(19) United States
(12) Patent Application Publication
(10) Pub. No.: US 2023/0221463 A1
(43) Pub. Date: Jul. 13, 2023

(54) METASURFACE OPTICAL DEVICE COVERED WITH REFLECTIVE LAYER, OPTICAL APPARATUS AND MANUFACTURING METHOD

(71) Applicant: Shphotonics Ltd, Suzhou (CN)

(72) Inventors: Lei SUN, Suzhou (CN); Bing QIU, Suzhou (CN)

(21) Appl. No.: 18/153,540

(22) Filed: Jan. 12, 2023

(30) Foreign Application Priority Data
Jan. 13, 2022 (CN) 202210038421.8

(51) Int. Cl. G02B 1/00

(52) U.S. Cl. CPC G02B 1/002

(57) ABSTRACT

A metasurface optical device includes a substrate, an optical medium layer disposed on the substrate, a plurality of nanoholes disposed in the optical medium layer, and a reflective layer covering sidewalls of the plurality of nanoholes. The plurality of nanoholes penetrate the optical medium layer and extend to the substrate.

### CROSS-REFERENCE TO RELATED APPLICATION

This application claims priority to Chinese Application No. 202210038421.8, filed on Jan. 13, 2022, the entire content of which is incorporated herein by reference.

### TECHNICAL FIELD

The present disclosure relates to the metasurface technology and, in particular, to a metasurface optical device covered with a reflective layer, an optical apparatus, and a method of manufacturing the metasurface optical device.

### BACKGROUND

Metasurface refers to an artificial two-dimensional material with the sizes of basic structure units smaller than the working wavelengths and in the order of nanometers in the near-infrared and visible band. Metasurface can realize flexible and effective control of the characteristics, such as amplitude, phase, polarization, propagation direction and mode, etc., of electromagnetic waves.

Metasurface is ultra-light, ultra-thin and multifunctional optical device. Compared with conventional optical devices, a metasurface optical device manufactured based on semiconductor technology has the advantages of excellent optical performance, small size, and high integration. Metasurface optical devices can be widely used in future portable and miniaturized devices, such as augmented reality wearable devices, virtual reality wearable devices, and mobile terminal lenses.

### SUMMARY

In accordance with the disclosure, there is provided a metasurface optical device including a substrate, an optical medium layer disposed on the substrate, a plurality of nanoholes disposed in the optical medium layer, and a reflective layer covering sidewalls of the plurality of nanoholes. The plurality of nanoholes penetrate the optical medium layer and extend to the substrate.

Also in accordance with the disclosure, there is provided an optical apparatus including a metasurface optical device. The metasurface optical device includes a substrate, an optical medium layer disposed on the substrate, a plurality of nanoholes disposed in the optical medium layer, and a reflective layer covering sidewalls of the plurality of nanoholes. The plurality of nanoholes penetrate the optical medium layer and extend to the substrate.

Also in accordance with the disclosure, there is provided a method of manufacturing a metasurface optical device. The method includes providing a substrate, forming an optical medium layer on the substrate, forming a plurality of nanoholes in the optical medium layer that penetrate the optical medium layer and extend to the substrate, and forming a reflective layer to cover sidewalls of the plurality of nanoholes.

### BRIEF DESCRIPTION OF THE DRAWINGS

Embodiments of the present disclose will be described below with reference to the accompanying drawings to provide further details, features, and advantages of the present disclosure.

FIG. 1 is a schematic structural diagram of a metasurface optical device.

FIG. 2 is a schematic diagram showing operation principle of an exemplary metasurface optical device.

FIG. 3 is a schematic structural diagram of an exemplary metasurface optical device according to some embodiments of the present disclosure.

FIG. 4 is a cross-sectional view of a plurality of nanoholes according to some embodiments of the present disclosure.

FIG. 5 is a schematic structural diagram of an exemplary optical apparatus according to some embodiments of the present disclosure.

FIG. 6 is a flowchart of an exemplary method of manufacturing a metasurface optical device according to some embodiments of the present disclosure.

### DETAILED DESCRIPTION OF THE EMBODIMENTS

In the following, some example embodiments are described. As those skilled in the art would recognize, the described embodiments can be modified in various different manners, all without departing from the spirit or scope of the present disclosure. Accordingly, the drawings and descriptions are illustrative in nature and not limiting.

In the present disclosure, terms such as “first,” “second,” and “third” can be used to describe various elements, components, regions, layers, and/or parts. However, these elements, components, regions, layers, and/or parts should not be limited by these terms. These terms are only used to distinguish one element, component, region, layer, or part from another element, component, region, layer, or layer. Therefore, a first element, component, region, layer, or part discussed below can also be referred to as a second element, component, region, layer, or part, which does not constitute a departure from the teachings of the present disclosure.

A term specifying a relative spatial relationship, such as “below,” “beneath,” “lower,” “under,” “above,” or “higher,” can be used in the disclosure to describe the relationship of one or more elements or features relative to other one or more elements or features as illustrated in the drawings. These relative spatial terms are intended to also encompass different orientations of the device in use or operation in addition to the orientation shown in the drawings. For example, if the device in a drawing is turned over, an element described as “beneath,” “below,” or “under” another element or feature would then be “above” the other element or feature. Therefore, an example term such as “beneath” or “under” can encompass both above and below. Further, a term such as “before,” “in front of,” “after,” or “subsequently” can similarly be used, for example, to indicate the order in which light passes through the elements. A device can be oriented otherwise (e.g., being rotated by 90 degrees or being at another orientation) while the relative spatial terms used herein still apply. In addition, when a layer is referred to as being “between” two layers, it can be the only layer between the two layers, or there can be one or more intervening layers.

Terminology used in the disclosure is for the purpose of describing the embodiments only and is not intended to limit the present disclosure. As used herein, the terms “a,” “an,” and “the” in the singular form are intended to also include the plural form, unless the context clearly indicates otherwise. Terms such as “comprising” and/or “including” specify the presence of stated features, entities, steps, operations, elements, and/or parts, but do not exclude the existence or addition of one or more other features, integers, steps, operations, elements, parts, and/or combinations thereof. As used herein, the term “and/or” includes any and all combinations of one or more of the listed items. The phrases “at least one of A and B” and “at least one of A or B” mean only A, only B, or both A and B.

When an element or layer is referred to as being “on,” “connected to,” “coupled to,” or “adjacent to” another element or layer, the element or layer can be directly on, directly connected to, directly coupled to, or directly adjacent to the other element or layer, or there can be one or more intervening elements or layers. In contrast, when an element or layer is referred to as being “directly on,” “directly connected to,” “directly coupled to,” or “directly adjacent to” another element or layer, then there is no intervening element or layer. “On” or “directly on” should not be interpreted as requiring that one layer completely covers the underlying layer.

In the disclosure, description is made with reference to schematic illustrations of example embodiments (and intermediate structures). As such, changes of the illustrated shapes, for example, as a result of manufacturing techniques and/or tolerances, can be expected. Thus, embodiments of the present disclosure should not be interpreted as being limited to the specific shapes of regions illustrated in the drawings, but are to include deviations in shapes that result, for example, from manufacturing. Therefore, the regions illustrated in the drawings are schematic and their shapes are not intended to illustrate the actual shapes of the regions of the device and are not intended to limit the scope of the present disclosure.

Unless otherwise defined, all terms (including technical and scientific terms) used herein have the same meaning as commonly understood by those of ordinary skill in the art to which this disclosure belongs. Terms such as those defined in commonly used dictionaries should be interpreted to have meanings consistent with their meanings in the relevant field and/or in the context of this disclosure, unless expressly defined otherwise herein.

As used herein, the term “substrate” can refer to the substrate of a diced wafer, or the substrate of an un-diced wafer. Similarly, the terms “chip” and “die” can be used interchangeably, unless such interchange would cause conflict. The term “layer” can include a thin film, and should not be interpreted to indicate a vertical or horizontal thickness, unless otherwise specified.

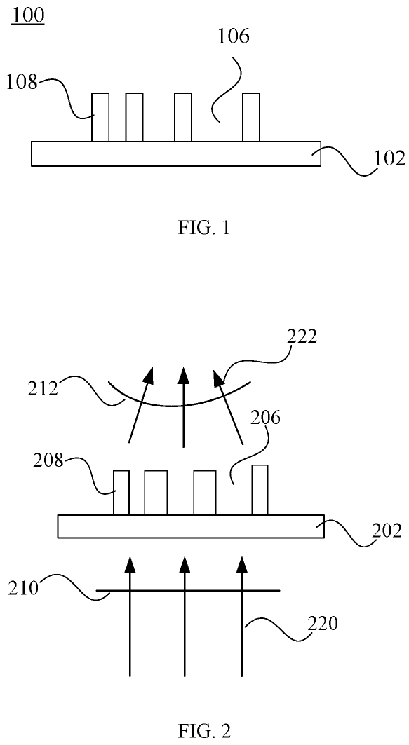

FIG. 1 is a schematic structural diagram of a metasurface optical device 100. As shown in FIG. 1, the metasurface optical device 100 includes a substrate 102, a plurality of nano-structure units (e.g., nanopillars) 108 arranged on the substrate 102, and an optical medium layer 106 protecting the plurality of nano-structure units 108. The plurality of nano-structure units 108 have a sub-wavelength size, and hence can realize local modulation of light at a corresponding operation wavelength. Further, the plurality of nano-structure units 108 may have different sizes, shapes, and arrangement periods on the substrate 102. When a light passes through the metasurface optical device 100, an array of the plurality of nano-structure units 108 flexibly and effectively regulates characteristics of the light such as polarization, amplitude, phase, polarization mode, and propagation mode. The optical medium layer 106 is arranged to surround the plurality of nano-structure units 108 for protection and support. In the metasurface optical device 100, a refractive index of a material of the plurality of nano-structure units 108 is greater than a refractive index of the optical medium layer 106, such that the light passing through the plurality of nano-structure units 108 mainly propagates therein.

FIG. 2 is a schematic diagram showing operation principle of an exemplary metasurface optical device. As shown in FIG. 2, when an incident light 220 enters the metasurface optical device, a portion of the incident light 220 enters the plurality of nano-structure units 208 through the substrate 202, and another portion of the incident light 220 enters the optical medium layer 206 through the substrate 202. Because the refractive index of the material of the plurality of nano-structure units 208 is greater than the refractive index of the optical medium layer 206, the portion of the incident light 220 entering the plurality of nano-structure units 208 mainly propagates inside the plurality of nano-structure units 208. The portion of the incident light 220 not entering the plurality of nano-structure units 208 passes directly through the optical medium layer 206. In this way, the metasurface optical device locally modulates an effective refractive index for the incident light 220 through the plurality of nano-structure units 208 thereon, and changes optical characteristics of the incident light 220, such as the polarization, amplitude, phase, polarization mode, and propagation mode, etc. As shown in FIG. 2, the incident light 220 originally having a planar wavefront 210 becomes an outgoing light 222 having a curved wavefront 212 after passing through the metasurface optical device, thereby realizing modulation of the wavefront of light.

However, in related art, the refractive index of the material of the plurality of nano-structure units and the refractive index of the optical medium layer need to meet certain requirements, that is, the refractive index of the material of the plurality of nano-structure units needs to be greater than the refractive index of the surrounding optical medium layer, such that the portion of the light incident entering the plurality of nano-structure units mainly propagates therein. Thus, selection of the materials of the plurality of nano-structure units and the optical medium layer in metasurface optical device is limited to a certain extent.

To solve the above problems, the present disclosure provides a metasurface optical device, an optical apparatus including the metasurface optical device, and a method of manufacturing the metasurface optical device. In the metasurface optical device, the optical medium layer disposed on the substrate includes a plurality of nanoholes penetrating through the optical medium layer and extending to the substrate. A reflective layer is covered on sidewalls of the plurality of nanoholes. As such, a portion of the incident light entering the plurality of nanoholes is reflected off the sidewalls of the plurality of nanoholes and is confined inside the plurality of nanoholes. That is, even the refractive index of the material (e.g., air) inside the plurality of nanoholes is smaller than the refractive index of the optical medium layer surrounding the plurality of nanoholes, the plurality of nanoholes can perform a function of the plurality of nanopillars in a metasurface optical device, that is, confining the light to propagate mainly inside the nanoholes.

In some embodiments, the metasurface optical device includes a substrate, an optical medium layer disposed on the substrate, and a plurality of nanoholes in the optical medium layer. The plurality of nanoholes extend through the optical medium layer to the substrate, and the sidewalls of the plurality of nanoholes are covered with a reflective layer.

In some embodiments, the substrate provides support for the optical medium layer. Types of the material of the substrate are not limited. For example, the substrate may include any one of glass, quartz, polymer, silicon, germanium, or plastic.

In some embodiments, the optical medium layer is made of a light-transmitting optical medium material. The optical medium material refers to any material that can transmit light by means of refraction, reflection, and transmittance. When the light is transmitted, the optical characteristics of the light, such as direction, intensity, and phase may be changed such that the light can be transmitted according to predetermined requirements. In some embodiments, types of the material of the optical medium layer are not limited. For example, the optical medium layer includes at least one of single crystal silicon, polycrystalline silicon, amorphous silicon, silicon carbide, titanium dioxide, silicon nitride, germanium, hafnium dioxide, or group III-V compounds. The group III-V compounds are compounds formed by boron, aluminum, gallium, indium of the group III in the periodic table of elements, and nitrogen, phosphorus, arsenic, antimony of the group V in the periodic table of elements, such as gallium phosphide, gallium nitride, gallium arsenide, indium phosphide, etc. For light transmittance efficiency purposes, in some embodiments, the optical medium layer does not include metallic materials (e.g., gold).

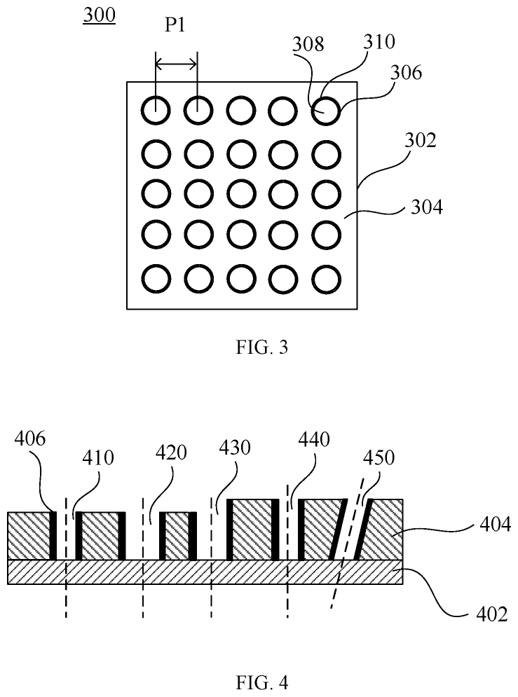

FIG. 3 schematically shows a metasurface optical device 300 consistent with the disclosure. As shown in FIG. 3, the metasurface optical device 300 includes a substrate 302, an optical medium layer 304 disposed on the substrate 302, and a plurality of nanoholes 310 in the optical medium layer 304. The plurality of nanoholes 310 extend through the optical medium layer 304 to the substrate 302, and sidewalls of the plurality of nanoholes 310 are covered with a reflective layer (shown by a black circle) 306.

In some embodiments, the plurality of nanoholes may be hollow structures, and the hollow structures may be filled with air. As shown in FIG. 3, a cavity 308 of a nanohole 310 is a hollow structure filled with air. Due to different effective refractive indices of different nanoholes 310, light will have phase differences after passing through different nanoholes 310, such that the plurality of nanoholes 310 can locally modulate the characteristics of the light, thereby changing the wavefront of the incident light.

In some other embodiments, the plurality of nanoholes may be filled with a filling material, and the refractive index of the filling material may be smaller than the refractive index of the optical medium layer. As shown in FIG. 3, the filling material with the refractive index smaller than the refractive index of the optical medium layer 304 is filled in the cavity 308 of the nanohole 310. The filling material may be, for example, monocrystalline silicon, polycrystalline silicon, amorphous silicon, silicon carbide, titanium dioxide, silicon nitride, germanium, hafnium dioxide, group III-V compounds, or other optical medium materials. According to actual application scenarios, the cavity 308 of the nanohole 310 may be filled with a corresponding filling material whose refractive index is lower than the refractive index of the optical medium layer 304, to flexibly change the effective refractive index of different nanoholes 310, thereby locally modulating the characteristics of light more flexibly to change the wavefront of the incident light.

In some embodiments, the arrangement period of the plurality of nanoholes on the substrate can be broadly construed as distances between respective geometric centers of adjacent nanoholes, as indicated by P1 in FIG. 3.

In some embodiments, the plurality of nanoholes may be arranged at a constant period on the substrate. As shown in FIG. 3, the arrangement period P1 of the plurality of nanoholes 310 on the substrate 304 is constant. In this scenario, if other parameters of the plurality of nanoholes 310 (e.g., a shape of the orthogonal projection of the nanohole on the substrate, a size of the orthogonal projection on the substrate, a size of the nanohole in a direction perpendicular to the substrate, etc.) vary, after the light passes through the plurality of nanoholes 310, the wavefronts thereof modulated by the different effective refractive indices can be obtained.

In some embodiments, the plurality of nanoholes are arranged at a non-constant period on the substrate. As shown in FIG. 3, the arrangement period P1 of the plurality of nanoholes 310 on the substrate 304 varies. Thus, after the light passes through the plurality of nanoholes 310, the wavefronts thereof modulated by the different effective refractive indices can be obtained.

In some embodiments, the plurality of nanoholes in the optical medium layer satisfy at least one of the following: the shapes of the orthogonal projections of the plurality of nanoholes on the substrate are not completely the same; the sizes of the orthogonal projections of the plurality of nanoholes on the substrate are not completely the same; the sizes of the plurality of nanoholes in the direction perpendicular to the substrate are not completely the same; the angles of the central axes of the plurality of nanoholes relative to the substrate are not completely the same; the orientations of the orthogonal projections of the plurality of nanoholes on the substrate are not completely the same; the filling materials in the plurality of nanoholes are not completely the same; and the arrangement patterns of different subsets of the plurality of nanoholes on the substrate are not completely the same.

In the specification, phrases like “parameters B of a plurality of A's are not completely the same” mean that the plurality of A's are intentionally designed such that the parameters B of the plurality of A's formed by the manufacturing process are not all the same. Thus, these parameters B that are not all the same should not be interpreted as the result of errors in the manufacturing process, and vice versa. For example, “the dimensions of the plurality of nano-structure units in the direction perpendicular to the substrate are not completely the same” means that the plurality of nano-structure units are designed in a way that their vertical dimensions are not all the same, and the difference in the vertical dimensions is not due to manufacturing process errors or measurement errors.

The structures and characteristics of the plurality of nanoholes are further described below with reference to FIG. 3 and FIG. 4.

In some embodiments, the shapes of the orthogonal projections of the plurality of nanoholes on the substrate may be the same. As shown in FIG. 3, the shapes of the orthogonal projections of the plurality of nanoholes 310 on the substrate 302 are all circular. In some other embodiments, the shapes of the orthogonal projections of the plurality of nanoholes 310 on the substrate 302 may also be an ellipse, a rectangle, a hexagon, a triangle, a sector, and the like. At this time, if other parameters of the plurality of nanoholes 310 (e.g., the sizes of the orthogonal projections on the substrate, the sizes in the direction perpendicular to the substrate, the arrangement patterns on the substrate, etc.) are changed, after the light passes through the plurality of nanoholes 310 with different effective refractive indices, the wavefronts thereof modulated by the different effective refractive indices can be obtained.

In some other embodiments, the shapes of the orthogonal projections of the plurality of nanoholes on the substrate may not be completely the same. For example, the shapes of the orthogonal projections of the plurality of nanoholes 310 on the substrate 302 may include two or more of circles, ellipses, rectangles, hexagons, triangles, sectors, and the like. Thus, after the light passes through the plurality of nanoholes 310 with different effective refractive indices, the wavefronts thereof modulated by the different effective refractive indices can be obtained.

In some embodiments, the sizes of the orthogonal projections of the plurality of nanoholes on the substrate may be the same. As shown in FIG. 3, the orthogonal projections of the plurality of nanoholes 310 on the substrate 302 are circles with a same radius. For example, the size of the orthogonal projections of the plurality of nanoholes 310 on the substrate 302 may be a radius of a circular orthogonal projection, a semi-major axis and a semi-minor axis of an ellipse orthogonal projection, a rectangular orthogonal projection, and lengths of sides of a hexagonal orthogonal projection and a triangle orthogonal projection, etc. In this scenario, if other parameters of the plurality of nanoholes 310 (e.g., the angles of central axes relative to the substrate, the sizes in the direction perpendicular to the substrate, the filling materials in the hollow structure of the plurality of nanoholes, etc.) vary, after the light passes through the plurality of nanoholes 310 with different effective refractive indices, the wavefronts thereof modulated by the different effective refractive indices can be obtained.

In some other embodiments, the sizes of the orthogonal projections of the plurality of nanoholes on the substrate may not be completely the same. For example, the orthogonal projections of the plurality of nanoholes 310 on the substrate 302 are circles with different radii, triangles with different side lengths, rectangles with different side lengths, hexagons with different side lengths, or ellipses with different semi-major axes and/or semi-minor axes. etc. Thus, after the light passes through the plurality of nanoholes 310 with different effective refractive indices, the wavefronts thereof modulated by the different effective refractive indices can be obtained.

In some embodiments, the sizes of the plurality of nanoholes in the direction perpendicular to the substrate may be the same.

The embodiments of the present disclosure will be described below with reference to FIG. 4, which is a cross-sectional view of a metasurface optical device consistent with the disclosure. As shown in FIG. 4, the metasurface optical device includes a substrate 402, an optical medium layer 404 disposed on the substrate 402, and a plurality of nanoholes 410-450 in the optical medium layer 404. The plurality of nanoholes 410-450 extend through the optical medium layer 404 directly to the substrate 402. The sidewalls of the plurality of nanoholes 410-450 are covered with a reflective layer 406. Taking the nanohole 410 and the nanohole 420 in FIG. 4 as an example, the sizes of the two in the direction perpendicular to the substrate 402 may be the same, that is, the nanohole 410 and the nanohole 420 in the optical medium layer 404 have a same depth. The arrangement of multiple nanoholes with a same size in the direction perpendicular to the substrate simplifies a manufacturing process of the metasurface optical devices. In this scenario, if other parameters of the plurality of nanoholes 310 (e.g., the angles of the central axes relative to the substrate, the sizes of the orthogonal projections on the substrate, the filling materials in the hollow structure of the plurality of nanoholes, etc.) vary, after the light passes through the plurality of nanoholes 310 with different effective refractive indices, the wavefronts thereof modulated by the different effective refractive indices can be obtained.

In some other embodiments, the sizes of the plurality of nanoholes in the direction perpendicular to the substrate may not be completely the same. Taking the nanohole 410 and the nanohole 440 in FIG. 4 as an example, in the direction perpendicular to the substrate, the size of the nanohole 440 is greater than the size of the nanohole 410, that is, in the optical medium layer 404, a depth of the nanohole 440 is greater than a depth of the nanohole 410. After the light passes through the plurality of nanoholes with different effective refractive indices, the wavefronts thereof modulated by the different effective refractive indices can be obtained.

In some embodiments, the angles of the central axes of the plurality of nanoholes relative to the substrate may be the same, and the angles may be 90 degrees or any value smaller than 90 degrees. Taking the nanohole 410 and the nanohole 440 shown in FIG. 4 as an example, the central axes (indicated by the dashed lines) of both have a same angle with respect to the substrate 402. Thus, after the light passes through the nanohole 410 and the nanohole 440, the light propagates in the same direction relative to the substrate 402.

In some other embodiments, the angles of the central axes of the plurality of nanoholes relative to the substrate may not be completely the same, and the angles may be 90 degrees or any value smaller than 90 degrees. As shown by the nanohole 410 and the nanohole 450 in FIG. 4, the angles of the central axes (indicated by the dashed lines) relative to the substrate 402 are different. Thus, after the light passes through the nanohole 410 and the nanohole 450, the light propagates along directions with different angles relative to the substrate 402.

In some embodiments, the orientations of the orthogonal projections of the plurality of nanoholes on the substrate may be the same. For example, the orthogonal projections of the plurality of nanoholes on the substrate may be at an angle relative to a reference direction. In this scenario, if other parameters of the plurality of nanoholes (e.g., the arrangement periods of the plurality of nanoholes, the sizes of the orthogonal projections on the substrate, the arrangement patterns on the substrate, etc.) vary, after the light passes through the plurality of nanoholes with different effective refractive indices, the wavefronts thereof modulated by the different effective refractive indices can be obtained.

In some other embodiments, the orientations of the orthogonal projections of the plurality of nanoholes on the substrate may not be completely the same. For example, the orthogonal projections of some nanoholes on the substrate may form one angle relative to a reference direction, and the orthogonal projections of some other nanoholes on the substrate may form another angle relative to the reference direction. For example, if the orthogonal projections of the plurality of nanoholes on the substrate are ellipses, the semi-major axes of the orthogonal projections of some of the nanoholes on the substrate may be at one angle relative to a reference direction, and the semi-major axes of the orthogonal projections of some other nanoholes on the substrate may be at another angle relative to the reference direction. Thus, after the light passes through the plurality of nanoholes with different effective refractive indices, the wavefronts thereof modulated by the different effective refractive indices can be obtained.

In some embodiments, the filling materials in the plurality of nanoholes may be the same. For example, the filling materials in the plurality of nanoholes may be one of monocrystalline silicon, polycrystalline silicon, amorphous silicon, silicon carbide, titanium dioxide, silicon nitride, germanium, hafnium dioxide, and group III-V compounds. In this scenario, if other parameters of the plurality of nanoholes (e.g., the arrangement periods of the plurality of nanoholes, the sizes of the orthogonal projections on the substrate, the shapes of the orthogonal projections on the substrate, etc.) vary, after the light passes through the plurality of nanoholes with different effective refractive indices, the wavefronts thereof modulated by the different effective refractive indices can be obtained.

In some other embodiments, the filling materials in the plurality of nanoholes may not be completely the same. For example, the filling material in some nanoholes may be one of monocrystalline silicon, polycrystalline silicon, amorphous silicon, silicon carbide, titanium dioxide, silicon nitride, germanium, hafnium dioxide, and group III-V compounds, and the filling material in some other nanoholes may be another one of single crystal silicon, polycrystalline silicon, amorphous silicon, silicon carbide, titanium dioxide, silicon nitride, germanium, hafnium dioxide, and group III-V compounds. Thus, after light passes through the plurality of nanoholes with different effective refractive indices, the wavefronts thereof modulated by the different effective refractive indices can be obtained.

In some embodiments, the arrangement patterns of different subsets of the plurality of nanoholes on the substrate may be the same. For example, the arrangement patterns of the plurality of nanoholes may be one of a rectangular pattern, a triangular pattern, a rhombus pattern, a hexagonal pattern, a random arrangement pattern, and the like. In this scenario, if other parameters of the plurality of nanoholes (e.g., the orientations of the orthogonal projections on the substrate, the sizes of the orthogonal projections on the substrate, the filling materials in the hollow structures of the plurality of nanoholes, etc.) vary, after the light passes through the plurality of nanoholes with different effective refractive indices, the wavefronts thereof modulated by the different effective refractive indices can be obtained.

In some other embodiments, the arrangement patterns of different subsets of the plurality of nanoholes on the substrate may not be completely the same. For example, the arrangement pattern of some nanoholes may be one of a rectangular pattern, a triangular pattern, a rhombus pattern, a hexagonal pattern, and a random arrangement pattern, etc., and the arrangement pattern of some other nanoholes may be another one of the rectangular pattern, the triangular pattern, the rhombus pattern, the hexagonal pattern, and the random arrangement pattern, etc. Thus, after the light passes through the plurality of nanoholes with different effective refractive indices, the wavefronts thereof modulated by the different effective refractive indices can be obtained.

In some embodiments, surfaces of the metasurface optical device other than the sidewalls of the plurality of nanoholes are not covered with the reflective layer. As shown in FIG. 4, the reflective layer 406 (black parts) only covers the sidewalls of the plurality of nanoholes 410-450, while bottom surfaces of the plurality of nanoholes 410-450 and top surfaces of the optical medium layer 404 are not covered with the reflective layer. Because there is no reflective layer in a direction parallel to the substrate 402, the light incident on the metasurface optical device can pass through the plurality of nanoholes 410-450 and the surrounding optical medium layer 404, thereby achieving a higher light transmittance rate.

In some embodiments, the reflective layer covering the sidewalls of the plurality of nanoholes may be a metal reflective layer. The metal reflective layer can totally reflect the light, thereby limiting the light entering the plurality of nanoholes to mainly propagate in the plurality of nanoholes. The material of the metal reflective layer may be a metallic material with a large extinction coefficient, a high reflectivity, and stable optical properties, such as gold, silver, copper, chromium, platinum, or aluminum, etc. Moreover, different metal materials may be used for light in different operation bands. For example, aluminum may be used in the ultraviolet wavelength region, aluminum and silver may be used in the visible light wavelength region, and gold, silver and copper may be used in the infrared wavelength region.

In some other embodiments, the reflective layer covering the sidewalls of the plurality of nanoholes may be a dielectric reflective layer. The dielectric reflective layer can totally reflect the light, thereby limiting the light entering the plurality of nanoholes to mainly propagate inside the plurality of nanoholes. In some embodiments, the refractive index of the material of the dielectric reflective layer is greater than the refractive index of the optical medium layer, such that the reflectivity of the optical medium layer is increased based on the principle of multi-beam interference. The material of the dielectric reflective layer is not limited. For example, the dielectric reflective layer may include at least one of single crystal silicon, polycrystalline silicon, amorphous silicon, silicon carbide, titanium dioxide, silicon nitride, germanium, hafnium dioxide, or group III-V compounds. The group III-V compounds are compounds formed by boron, aluminum, gallium, indium of group III in the periodic table of elements and nitrogen, phosphorus, arsenic, antimony of group V in the periodic table of elements, such as gallium phosphide, gallium nitride, gallium arsenide, and indium phosphide, etc.

In some other embodiments, the reflective layer covering the sidewalls of the plurality of nanoholes may be a metal-dielectric reflective layer. Because the metal reflective layer made of aluminum, silver, copper, and other materials is easily oxidized in the air, which degrades its performance, the metal reflective layer may be covered with a dielectric layer for protection. The material of the dielectric layer may be dielectric materials such as silicon monoxide, magnesium fluoride, silicon dioxide, or aluminum oxide.

In some embodiments, the reflective layer covering the sidewalls of the plurality of nanoholes may be of a same type. For example, the reflective layer may be one of the metal reflective layer, the dielectric reflective layer, and the metal-dielectric reflective layer. Using the same type of the reflective layer reduces the complexity of the manufacturing process, and the plurality of nanoholes can have same optical reflection characteristics.

In some other embodiments, the reflective layer covering the sidewalls of the plurality of nanoholes may be of different types. For example, the reflective layer may be multiple types of the metal reflective layer, the dielectric reflective layer, and the metal-dielectric reflective layer. Using different types of the reflective layer makes the plurality of nanoholes have different optical reflection characteristics.

In some embodiments, the surface of the substrate facing away from the optical medium layer and/or the surface of the substrate facing toward the optical medium layer may be covered with the reflective layer. In some embodiments, the reflective layer completely covers the side of the substrate where the plurality of nanoholes are arranged, and is disposed between the optical medium layer containing the plurality of nanoholes and the substrate. In some other embodiments, the reflective layer completely covers the other side of the substrate, that is, completely covers the side of the substrate where no nanohole is arranged.

The type of the reflective layer is not limited. In some embodiments, the reflective layer may be one of the metal reflective layer, the dielectric reflective layer, and the metal-dielectric reflective layer with relatively high reflectivity. By adding the reflective layer with the relatively high reflectivity, the metasurface optical device provided by the present disclosure can be used as a reflective component, reflecting back locally modulated light through the plurality of nanoholes instead of allowing the locally modulated light to pass through the metasurface optical device.

In some other embodiments, the reflective layer may be a grating or a dielectric material layer. In this scenario, after the light enters the metasurface optical device provided by the present disclosure, the light is neither completely transmitted nor fully reflected. A portion of the light is transmitted through the metasurface optical device, and another portion of the light is reflected back. A ratio of transmitted light over reflected light may be adjusted according to actual usage needs. In one example, 80% of the light may be transmitted and 20% of the light may be reflected. In another example, 20% of the light may be transmitted and 80% of the light may be reflected. In another example, 50% of the light may be transmitted and 50% of the light may be reflected. When the reflective layer is a grating (the grating is surrounded by a dielectric material to make its surface flat, and the reflective layer includes a multilayer grating), the refractive index of the grating, the refractive index of the material between each layer of grating, and the thickness thereof, etc. may be controlled to adjust the ratio of the transmitted light over the reflected light. When the reflective layer is a dielectric material layer, the ratio of the transmitted light over the reflected light may be adjusted by changing a refractive index difference between the dielectric material layer and the substrate.

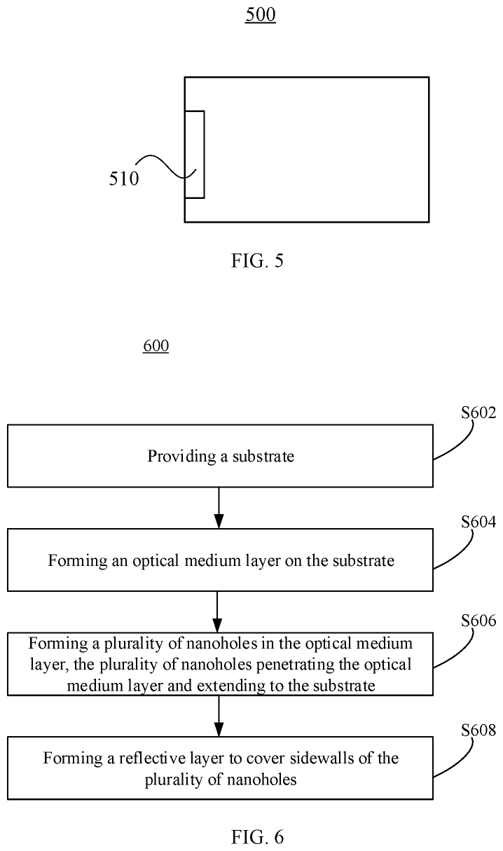

FIG. 5 shows an optical apparatus 500 consistent with the disclosure. As shown in FIG. 5, the optical apparatus 500 includes a metasurface optical device 510. The metasurface optical device 510 may be a metasurface optical device consistent with the disclosure, such as one of the example metasurface optical devices described above. The specific product type of the optical apparatus 500 is not limited. For example, the optical apparatus 500 may be a lens of an augmented reality wearable device, a virtual reality wearable device, a mobile terminal, etc., or a spectrometer, a microscope, a telescope, or the like.

FIG. 6 is a flowchart of a method 600 of manufacturing a metasurface optical device consistent with the disclosure. As shown in FIG. 6, the method 600 includes the following processes.

At S602, a substrate is provided. The substrate supports light transmittance and provides support for the optical medium layer disposed thereon. The material type of the substrate is not limited. For example, the substrate may include any one or more of glass, quartz, polymer, and plastic.

At S604, an optical medium layer is formed on the substrate. The optical medium layer supports light transmittance and covers the substrate. The material type of the optical medium layer is not limited. For example, the optical medium layer may include at least one of single crystal silicon, polycrystalline silicon, amorphous silicon, silicon carbide, titanium dioxide, silicon nitride, germanium, hafnium dioxide, or group III-V compounds. The group III-V compounds are compounds formed by boron, aluminum, gallium, indium of group III in the periodic table of elements, and nitrogen, phosphorus, arsenic, antimony of group V in the periodic table of elements, such as gallium phosphide, gallium nitride, gallium arsenide, and indium phosphide, etc.

At S606, a plurality of nanoholes are formed in the optical medium layer, and the plurality of nanoholes penetrate the optical medium layer and extend to the substrate. In some embodiments, the process may include: film coating to sequentially form a hard mask and a photolithography stack layer on the optical medium layer; photolithographing to form a plurality of nanohole shapes in the photolithography stack layer; etching to form a plurality of nanohole shapes in the hard mask; ion-beam etching or reactive ion-beam etching to form a plurality of nanohole shapes in the optical medium layer; removing the hard mask; and chemically-mechanically polishing to planarize the surface of the metasurface optical device. The above operations may be combined and sequenced according to actual processing needs.

At S608, a reflective layer is formed to cover sidewalls of the plurality of nanoholes. In some embodiments, an atomic layer deposition process may be used to form the reflective layer on the sidewalls of the plurality of nanoholes, and the thickness of the reflective layer is usually several nanometers to over ten nanometers.

In the embodiments of the present disclosure, the sidewalls of the plurality of nanoholes extending through the optical medium layer to the substrate are covered with the reflective layer. In addition, the refractive index of the filling material in the plurality of nanoholes is smaller than the refractive index of the optical medium layer surrounding the plurality of nanoholes. Thus, the light entering the plurality of nanoholes can be totally reflected by the sidewalls of the plurality of the nanoholes, thereby confining the light to propagate mainly inside the plurality of the nanoholes.

Several different embodiments or examples are described in the present disclosure. These embodiments or examples are exemplary and are not intended to limit the scope of the present disclosure. Those skilled in the art can conceive of various modifications or substitutions based on the disclosed contents, and such modifications and substitutions should be included in the scope of the present disclosure. A true scope and spirit of the invention is indicated by the following claims.

What is claimed is:

1. A metasurface optical device comprising:
a substrate;
an optical medium layer disposed on the substrate;
a plurality of nanoholes disposed in the optical medium layer, the plurality of nanoholes penetrating the optical medium layer and extending to the substrate; and
a reflective layer covering sidewalls of the plurality of nanoholes.

2. The metasurface optical device of claim 1, wherein the plurality of nanoholes are hollow structures filled with air.

3. The metasurface optical device of claim 1, further comprising:
a filling material filled in the plurality of nanoholes, a refractive index of the filling material being smaller than a refractive index of the optical medium layer.

4. The metasurface optical device of claim 1, wherein shapes of orthogonal projections of the plurality of nanoholes on the substrate are not completely same.

5. The metasurface optical device of claim 1, wherein sizes of orthogonal projections of the plurality of nanoholes on the substrate are not completely same.

6. The metasurface optical device of claim 1, wherein sizes of the plurality of nanoholes in a direction perpendicular to the substrate are not completely same.

7. The metasurface optical device of claim 1, wherein angles of central axes of the plurality of nanoholes relative to the substrate are not completely same.

8. The metasurface optical device of claim 1, wherein orientations of orthogonal projections of the plurality of nanoholes on the substrate are not completely same.

9. The metasurface optical device of claim 1, wherein filling materials in the plurality of nanoholes are not completely same.

10. The metasurface optical device of claim 1, wherein arrangement patterns of different subsets of the plurality of nanoholes on the substrate are not completely same.

11. The metasurface optical device of claim 1, wherein the plurality of nanoholes are arranged at a constant period on the substrate.

12. The metasurface optical device of claim 1, wherein the plurality of nanoholes are arranged at non-constant periods on the substrate.

13. The metasurface optical device of claim 1, wherein the reflective layer includes at least one of a metal reflective layer, a dielectric reflective layer, or a metal-dielectric reflective layer.

14. The metasurface optical device of claim 1, wherein the reflective layer does not cover surfaces of the metasurface optical device other than the sidewalls of the plurality of nanoholes.

15. The metasurface optical device of claim 1, wherein the reflective layer further covers at least one of a surface of the substrate facing away from the optical medium layer or a surface of the substrate facing toward the optical medium layer.

16. An optical apparatus comprising a metasurface optical device including:
a substrate;
an optical medium layer disposed on the substrate;
a plurality of nanoholes disposed in the optical medium layer, the plurality of nanoholes penetrating the optical medium layer and extending to the substrate; and
a reflective layer covering sidewalls of the plurality of nanoholes.

17. The optical apparatus of claim 16, wherein the plurality of nanoholes are hollow structures filled with air.

18. The optical apparatus of claim 16, wherein the metasurface optical device further includes:
a filling material filling the plurality of nanoholes, a refractive index of the filling material is smaller than a refractive index of the optical medium layer.

19. The optical apparatus of claim 16, wherein the reflective layer further covers at least one of a surface of the substrate facing away from the optical medium layer or a surface of the substrate facing toward the optical medium layer.

20. A method of manufacturing a metasurface optical device comprising:
providing a substrate;
forming an optical medium layer on the substrate;
forming a plurality of nanoholes in the optical medium layer, the plurality of nanoholes penetrating the optical medium layer and extending to the substrate; and
forming a reflective layer to cover sidewalls of the plurality of nanoholes.
